(19) United States
(12) Patent Application Publication
(10) Pub. No.: US 2023/0284655 A1
(43) Pub. Date: Sep. 14, 2023

(54) INCREASING THE METABOLIC ENERGY IN ANIMAL FEED

(71) Applicant: Alzchem Trostberg GmbH, Trostberg (DE)

(72) Inventors: Jürgen SANS, Trostberg (DE); Stephan WINKLER, Altenmarkt (DE)

(73) Assignee: Alzchem Trostberg GmbH, Trostberg (DE)

(21) Appl. No.: 18/008,499

(22) PCT Filed: Jun. 11, 2021
(86) PCT No.: PCT/EP2021/065778

§ 371 Date: Mar. 20, 2023

(30) Foreign Application Priority Data
Jun. 15, 2020 (DE) 10 2020 115 667.7

(51) Int. Cl. A23K 20/142; A23K 10/30; A23K 50/10

(52) U.S. Cl. CPC A23K 20/142; A23K 10/30; A23K 50/10

(57) ABSTRACT

The present invention relates to the use of guanidine, guanidinoacetic acid and arginine and salts thereof for increasing the metabolic energy of a ruminant feed.

The present invention relates to the use of guanidine, guanidinoacetic acid and arginine or salts thereof for increasing the metabolic energy of a ruminant feed.

The use of low-cost alternative feeds to replace or supplement locally available feeds has long been the subject of agricultural research, particularly in times of lacking availability of local feeds. For example, a protein substitute has already been proposed in DE 738131, which can be used in the absence of protein supply with natural local feed. The disadvantage of this method is that no influence is exerted on the available feed. The utilization of the available feed in the stomach and digestive tract of the animals is not improved.

An increase in efficiency in the husbandry of farm animals, especially chickens, laying hens and broilers, has been achieved by additives. It has long been known that creatinyl phosphate phosphorylates ADP to ATP and thus makes an important contribution to energy metabolism in the cell. Thus, it is described in EP 1758463 B1 that supplementation of the precursor compound of creatinyl phosphate, namely with guanidinoacetic acid, in predominantly vegetarian diets helps to improve feed intake, increase fattening performance, muscle meat gain, meat quality and/or reproductive performance. The disadvantage of this method is that it also does not directly influence the feed in the digestive tract. The utilization of the available feed in the stomach and digestive tract of the animals is not improved, i.e. the metabolic energy is not increased.

The improvement of feed intake in farm animals, such as cows, pigs or chickens, has also often been studied because of its great economic importance. Since the farm animals should grow quickly or lay many eggs quickly or give as much nutritious milk as possible, a large amount of energy must be put into the animal in each case. To achieve this, attempts have been made, for example, to increase the feed intake frequency in dairy cows. For example, it is shown in EP 2939545 B1 that the feed intake behavior of dairy cows can be improved by adding green fodder aromas to the feed. However, a disadvantage of this method is that a larger amount of feed is eaten by the animals. Again, the utilization of the available feed in the stomach and digestive tract is not improved.

Furthermore, coffee components that improve feed efficiency are described in EP 3479700 A1. These coffee components must be fermented in a complex manner with the aid of a bacterium. The disadvantage of this process is thus that an additional treatment step of fermentation is necessary.

Thus, according to the state of the art, numerous methods are known which, through the use of additives to feeds, bring farm animals to more rapid growth. This can be done by feed substitutes, by flavourings or by endogenous substances which influence the cell metabolism. In addition, a number of additives are known to compensate for deficiencies in the feed mixture. Examples are methionine, lysine, calcium and other metal salts and vitamins.

No practicable solution exists for the economically and ecologically most urgent task, namely to make the animals' feed more readily available to them without chemical or mechanical pre-treatment.

Thus, the underlying object of the present invention is to identify an additive which acts in a simple application without prior external additional mechanical or thermal effort, i.e. directly in the digestive tract of the animals, and increases the metabolic energy of a given feed or feed mixture. Here, the increase of the metabolic energy of a given feed is equivalent to the promotion of the digestibility of a feed in the digestive tract of the animals.

The total energy contained in a feed, also called calorific value, is the gross energy [GE]. It includes the total energetic potential of the feed. If the energy that leaves the body via the faeces is subtracted from the gross energy, the digestible energy [DE] is obtained. If the energies contained in the urine and fermentation gases is subtracted from the digestible energy, the convertible energy, also called metabolic energy [ME] or metabolizable energy, is obtained (Burgstaller G. (1999): Praktische Rinderfütterung, Landbuch Publishers, Hannover). This metabolic energy is used as an indication in the feeding of ruminants, such as cattle for fattening and rearing, sheep and goats.

The metabolic energy still includes the animal's maintenance requirement. If this maintenance requirement, measured in the form of metabolic heat, is subtracted from the metabolic energy, the net energy available for production output is obtained. In the case of feeding dairy cows, this would be the energy available for milk production. This is then called net energy lactation in the case of milk feeding.

Metabolic energy is therefore an important parameter characterizing a feed or feed mixture. It is important both to ensure that the animals are always provided with the required energy and for the trade in feeds. Since it would be very laborious and require a great deal of experimental effort to determine it according to the above derivation, simple methods were sought to determine the metabolic energies of feeds or feed mixtures simply on the basis of relatively easily accessible laboratory analyses.

A method for determining the metabolic energy (ME) of feeds follows the equation below. This equation was recommended by the Society for Nutritional Physiology [https://gfefrankfurt.files.wordpress.com/2018/08/me-prediction-compound_feeds_deutsch_wk.pdf, formula p. 3] and has been adopted by legislature in feed law since 1 Sep. 2010. Accordingly, the metabolic energy of compound feed is calculated by the following formula, which is binding under feed law:

ME, MJ/kg DM=7.17−0.01171×crude ash [g/kg DM]+0.00712×crude protein [g/kg DM]+0.01657×crude fat [g/kg DM]+0.00200×starch [g/kg DM]−0.00202×ADForg*[g/kg DM]+0.06463×gas formation [ml/200 mg DM]

*ADForg=acid detergent fibres, ash-free; DM: dry matter

Positive contributions to metabolic energy are provided by the summands crude protein content, crude fat content, starch content and the gas formation rate, measured according to the Hohenheim Feed Value Test (HFT) (see e.g. VDLUFA Publishers, 8th Suppl. 2013, Method Manual III, 25.1). Negative contributions to metabolic energy are provided by the summands crude ash content and acid detergent fibre content (ADF_{org}). This is unsurprising since the ash contents ultimately represent the inorganic salts from which no energy can be derived. The acid-detergent fibres (ADF_{org}) represent cellulose and lignin, which are difficult or impossible for animals to digest and therefore make a negative contribution to the metabolic energy of a feed according to the formula above.

The parameters crude ash, crude protein, crude fat, starch, ADF_{org} are determined directly on feed samples. These parameters are unchangeable for a given feed or feed mixture and are not influenced by any additives that are additionally applied to the animal.

The gas formation according to the HFT simulates the processes in the digestive tract. Since in the HFT rumen fluid is added to a feed or feed mixture and the gas formation is measured within 24 h, the gas formation simulates the processes in the digestive tract of ruminants. This value can be influenced by additives administered to the animal. These additives could be given on their own, with the drinking water or ideally with the feed directly to the animal.

Accordingly, an additive is sought which is added to a feed or a feed mixture and which, by its addition to a feed or feed mixture, causes an increase in the amount of gas formed in the Hohenheim Feed Value Test and thus causes an increase in the metabolic energy of a feed.

The additional amount of gas formed means an additional excess amount of metabolic energy obtained from a feed or feed mixture and available to the animal. An additive that increases the amount of gas in the HFT in a given feed will therefore improve digestibility in the animals' digestive tract.

The problem underlying the invention is solved by a use according to claim 1 or 2. Surprisingly, the addition of guanidine, guanidinoacetic acid or arginine to a feed for ruminants promotes the digestibility of a given feed or feed mixture in the digestive tract of ruminants. Thus, according to a first embodiment, the use of a compound selected from the group comprising guanidine, guanidinoacetic acid and arginine and salts thereof to increase metabolic energy from feeds for ruminants comprising straw and/or maize is an object of the present invention. Thus, according to a second embodiment, the use of a compound selected from the group of guanidine, guanidinoacetic acid and arginine and salts thereof for increasing the metabolic energy of a feed containing straw and/or maize in the digestive tract of ruminants is also an object of the present invention.

Quite unexpectedly, more metabolic energy is released from the feed itself when feed is supplemented with either guanidine or guanidinoacetic acid or arginine compared to digestion without the addition of these additives. Thus, more metabolic energy can be provided to the ruminant from a feed ration by the addition of guanidine, guanidinoacetic acid or arginine when the same amount of feed is administered. This additional energy release is due solely to the addition of guanidine, guanidinoacetic acid or arginine, the energy not resulting from the compound itself.

What is completely surprising is that this additional energy does not result from the additives themselves. It could be shown that GAA is not degraded in the rumen of a ruminant (cf. examples).

Guanidinoacetic acid (abbreviated GAA) according to the present invention means N-(aminoiminomethyl)-2-aminoacetic acid (CAS No. 352-97-6, molecular formula C₃H₇N₃O₂) and is also known as guanidinoacetate, glycocyamine, N-amidinoglycine, N-(aminoiminomethyl)-glycine.

Arginine (abbreviated Arg) according to the present invention means α-amino-δ-guanidino-valeric acid in all stereochemical forms and mixtures thereof (CAS No. 74-79-3-L-arginine, CAS No. 157-06-2-D-arginine, CAS No. 7200-25-1-racemate, molecular formula C₆H₁₄N₄O₂).

Guanidine according to the present invention means aminomethanamidine (CAS No. 113-00-8, molecular formula CH₅N₃) and is also known as iminourea.

Preferred according to the invention is the use of guanidinoacetic acid (GAA) and/or salts thereof for increasing the metabolic energy of a feed for ruminants containing straw and/or maize. Further preferred is the use of guanidinoacetic acid (GAA) and salts thereof for increasing the metabolic energy of a feed containing straw and/or maize in the digestive tract of ruminants.

Metabolic energy according to the present invention is the metabolic energy of a feed determined according to the Hohenheim Feed Value Test.

Straw according to the present invention means threshed and dried stalks and leaves of cereals, oil plants, fiber plants or legumes.

The basic aim of a feed test is to determine the behavior of a feed in the digestive tract. There are various methods for simulating the processes in the digestive area, which are mostly adapted to the respective digestion. In humans and other monogasters, a sample is usually first stored at the pH of the stomach and with stomach enzymes for a defined time and at a defined temperature and then the products are analyzed. A recognized test for ruminant feed is the Hohenheim Feed Value Test, in which a feed sample is mixed with rumen juice and gas formation is determined. Gas formation contributes to the metabolic energy of a feed (see above).

Thus, according to a further idea, the use of a compound selected from the group comprising guanidine, guanidinoacetic acid and arginine and salts thereof for increasing gas formation from a feed for ruminants is also an object of the present invention.

The primary objective of feeding livestock is maximum utilization of the metabolic energy of the feed. It has been shown that gas release in the HFT contributes to the metabolic energy of the feed. In addition, there may be processes that are interested in high gas release from feed. These are, for example, the recovery of gases directly from plants or plant components as well as from manure. Since the main component of manure comes from the digestive tract of the animals and the enzymes of the rumen fluid are present there, the addition of guanidine, guanidinoacetic acid and arginine can increase the gas yield of biogas plants or increase the conversion rate of manure and plants and plant components to gas.

According to the present invention, guanidine, guanidinoacetic acid and arginine may be used to increase the metabolic energy of a feed. In this regard, said compounds may be used as such as well as in the form of their salts. Preferably, salts from the group of alkali salts, alkaline earth salts or hydrochlorides can be used as salts of these compounds.

Guanidinoacetic acid or salts thereof, in particular salts of guanidinoacetic acid from the group of alkali salts, alkaline earth salts or hydrochlorides are particularly preferred.

Preferably, these compounds or salts thereof may be added to the feed and in particular administered to ruminants together with straw and/or maize. Further preferably, the straw may be selected from the group of barley straw, wheat straw, oat straw, rye straw, triticale straw, millet straw, and/or the maize may be used in the form of cob maize, husk cob meal, maize meal, green maize, silage maize, whole plant silage maize.

According to the invention, the feed for ruminants containing straw and/or maize preferably comprises at least 30% by weight, preferably at least 40% by weight and even more preferably at least 50% by weight of straw and/or maize, in each case based on the total weight of the feed. Still more preferably, the feed largely or essentially consists of straw and/or maize and comprises at least 60% by weight, in particular at least 70% by weight, preferably at least 80% by weight and more preferably at least 90% by weight of straw and/or maize, in each case based on the total weight of the feed.

In this context, the compounds according to the invention or their salts can preferably be added to the feed in an amount of 0.01 to 2% by weight, based on the feed. Particularly preferably, the compounds according to the invention or their salts can be added to the feed in an amount of 0.05 to 1.5% by weight and very particularly preferably in an amount of 0.05 to 1.0% by weight and even more preferably in an amount of 0.10 to 1.0% by weight, in each case based on the feed.

Preferably, the compounds according to the invention or their salts can be added to the feed preferably in an amount of 0.01 to 2% by weight, based on the straw and/or maize. Particularly preferably, the compounds according to the invention or the salts thereof can be added to the straw and/or the maize in an amount of 0.05 to 1.5% by weight and very particularly preferably in an amount of 0.05 to 1.0% by weight and even more preferably in an amount of 0.10 to 1.0% by weight, in each case based on the straw and/or the maize.

The application or form of application may be in any form. Preferred, however, is a use in which the compound according to the invention or its salts are added to the feed in the form of a granulate, extrudate or as a solution. Particularly preferred, however, is a use as a solution. Very particularly preferably, it may also be provided that the compounds according to the invention or their salts are applied onto a carrier material.

The use according to the invention of the compounds selected from the group of guanidine, guanidinoacetic acid and arginine and salts thereof, and in particular of guanidinoacetic acid and salts thereof, has been shown to be very effective in the feeding of ruminants. These animals have in common that they have a rumen in the digestive tract of their body. Thus, the use according to the invention is initially applicable to any ruminant without limitation.

Preferably, however, the use may be applied to ruminants from the group of cattle, dairy cows, sheep or goats.

The invention similarly comprises a method for increasing the metabolic energy of a feed for ruminants containing straw and/or maize, comprising the steps of
providing a feed for ruminants containing straw and/or maize,
adding a compound selected from the group of guanidine, guanidinoacetic acid and arginine and salts thereof to the feed,
administering the feed to ruminants, and
increasing the metabolic energy of the feed in the digestive tract of the ruminants.

Preferred embodiments of the method according to the invention are as disclosed herein in the uses according to the invention.

The following examples shall further explain the essence of the invention.

### EXAMPLES

The Hohenheim Feed Value Test (HFT) [VDLUFA Publishers, 8th Suppl. 2013, Method Manual III, 25.1] was used to estimate the relative digestibility of feeds. In the HFT, a feed is dispersed in buffered rumen juice in a sample flask and incubated at 39° C. for 24 h. The volume of gas produced during this time is measured and represents the gas formation value. A higher gas formation represents a higher feed value.

### A) Feeds Examined

Maize silage: Maize of the KWS Gunnario variety, cultivated in 2019, Altötting district, was harvested with a maize chopper (cutting height 20 cm above ground level) and properly stored and ensilaged. The sample for the investigations was taken 6 months after storage. The sampling point was fresh at 70 cm depth. The sample was stored in an airtight bag until testing. Water content (4 h, 103° C.): 9.0%, crude ash: 2.9%.

Maize, crushed fodder maize, Kornkraft Company: water content (4 h, 103° C.): 13.2%; crude ash: 1.2%.

Barley straw, winter barley, Padura variety, chopped, maximum length<1 cm, cultivated in 2019, Altötting district: water content (4 h, 103° C.): 8.8%; crude ash: 4.6%.

Wheat straw, winter wheat, Boss variety, chopped, maximum length<1 cm, cultivated in 2019, Mühldorf district: water content (4 h, 103° C.): 8.6%; crude ash: 3.7%.

Hay, 2nd cut 2019, Traunstein district, post-dried: water content (4 h, 103° C.): 8.8%; crude ash: 6.5%.

Oat grains, kilned, pressed, dried, brand: Knusperone, manufacturer: H & J Brüggen K G, water content (4 h, 103° C.): 8.4%, crude ash: 2.1%

### B) Additives Used

| | |
|---|---|
| guanidinoacetic acid (GAA) | content: 99% (Sigma Aldrich) |
| (CAS 352-97-6) | |
| guanidine hydrochloride (Guhy). | content: ≥ 98.0% (Merck GmbH) |
| (CAS 50-01-1) | |
| 1,1,3,3-tetramethylguanidine (TMG) | content: 99% (Sigma Aldrich) |
| (CAS 80-70-6) | |
| creatine monohydrate (creatine) | content: ≥ 98.0% (Merck GmbH) |
| (CAS 6020-87-7) | |
| L-arginine (L-Arg) | content: ≥ 98% (Merck GmbH) |
| (CAS 74-79-3) | |

### C) Preparation of the Feeds

Of the additives used, an aqueous solution with a concentration of 4 g/l was prepared in each case with demineralized water. 100 g of each feed was placed in a glass cylinder, 260 mm in diameter, and the glass cylinder was attached to a multi-piston shaker (VKS 75 A control, Edmund Bühler GmbH). The multi-piston shaker was then set to a speed of 70 min⁻¹ and the amount of aqueous solution was applied to the feed substrate using a standard household manual pressurized water sprayer until the desired target amount of additive was sprayed. The treated feed was then dried at 50° C. in a vacuum drying cabinet 24 h to remove excess water. To exclude the possibility that the treatment with water and drying at elevated temperature in a vacuum had an influence, the reference feed samples containing demineralized water were treated in the same way (=untreated feed).

### D) Result of the Investigation

The results of the investigation are summarized in Table 1 and Table 2.

TABLE 1
Gas formation (HFT) [ml/ 200 mg] of different feeds;
Reference value (=untreated feed) and additives in various amounts
(% by weight of feed)

| | | | | | | L- | | |
|---|---|---|---|---|---|---|---|---|
| | | GAA | | | Guhy | Arginine | TMG | Creatine |
| | Refer- | 0.05 | 0.1 | 1.0 | 0.1 | 0.1 | 0.1 | 0.1 |
| Feed | ence | wt % | wt % | wt % | wt % | wt % | wt % | wt % |
| Maize | 46.2 | | | 48.8 | | | | |
| silage | | | | | | | | |
| Maize | 57.7 | | | 58.7 | | | | |
| (grains) | | | | | | | | |
| Straw | 22.6 | 23.4 | 25.5 | 25.3 | 23.8 | 25.9 | 21.7 | 22.2 |
| (barley) | | | | | | | | |
| Straw | 17.3 | | 19.5 | 20.2 | | | | |
| (wheat) | | | | | | | | |
| Hay | 38.7 | | | 38.4 | | | | |
| Oats | 56.6 | | 56.2 | 56.5 | | | | |
| (pressed) | | | | | | | | |

TABLE 2
Absolute increase and percentage increase of the gas formation value upon addition
of GAA to different feeds relative to the reference

| | | | Absolute increase | Percentage increase |
|---|---|---|---|---|
| | | 1.0 % by weight | of the gas | of the |
| | Reference | GAA | formation value | gas formation value |
| Feed | [ml/200 mg] | [ml/200 mg] | [ml/200 mg] | [%] |
| Maize silage | 46.2 | 48.8 | 2.6 | 5.63 |
| Maize (grains) | 57.7 | 58.7 | 1.0 | 1.73 |
| Straw (barley) | 22.6 | 25.3 | 2.7 | 11.95 |
| Straw (wheat) | 17.3 | 20.2 | 2.9 | 16.76 |
| Hay | 38.7 | 38.4 | -0.3 | -0.78 |
| Oats (pressed) | 56.6 | 56.5 | -0.1 | -0.18 |

### E) Stability of GAA in Rumen Fluid

The determination of the stability of GAA in rumen fluid was carried out following the procedure of the HFT test. For this purpose, 50 ml wide-mouth bottles with slotted lids were incubated in a shaking water bath (10 ml rumen juice+40 ml buffer, 500 mg feed weight (total mixed ration) and varying amounts of GAA). The incubation period was 0 h, 8 h, 24 h.

Subsequently, the contents of the wide-mouth bottle were rinsed over into a plastic cup, freeze-dried and the amount of GAA in the freeze-dried sample was determined.

TABLE 3
Stability of GAA in the rumen

| GAA sample | Incubation time | GAA quantity | Recovery rate |
|---|---|---|---|
| weight [mg] | [h] | analyzed | [%] |
| 9 | 0 | 9.90 | 110 |
| 10 | 0 | 9.94 | 99.4 |
| 10 | 0 | 9.79 | 97.9 |
| 10 | 8 | 9.83 | 98.3 |
| 10 | 8 | 98.63 | 86.3 |
| 10 | 8 | 10.07 | 100.7 |
| 10 | 24 | 10.14 | 101.4 |
| 10 | 24 | 9.61 | 96.1 |
| 10 | 24 | 11.24 | 112.4 |
| 40 | 0 | 40.06 | 100.15 |
| 40 | 0 | 39.08 | 97.7 |
| 39 | 0 | 38.41 | 98.49 |
| 40 | 8 | 38.60 | 96.5 |
| 40 | 8 | 39.15 | 97.88 |
| 40 | 8 | 38.36 | 95.9 |
| 40 | 24 | 38.51 | 96.28 |
| 40 | 24 | 39.02 | 97.55 |
| 40 | 24 | 39.46 | 98.65 |

In the tests with the low sample weight (10 mg GAA), relatively large fluctuations occur due to the analysis. In the blank test (0 h incubation time), 98.78% of the added GAA was recovered on average from the 3 tests with the higher sample weight (40 mg GAA). After 8 h, an average of 96.76% and, after 24 h, 97.44% of the GAA was recovered. It can therefore be assumed that GAA is at least almost completely stable in rumen fluid.

### F) Result Evaluation

The addition of GAA led to an increase in the amount of gas formed in maize silage, maize, and the two straw varieties.

In the case of barley straw, an increase in gas formation was obtained up to an additive level of 0.1% GAA, namely from 22.6 ml/200 mg without additive to 23.4 ml/200 mg with the addition of 0.05% GAA and further to 25.5 ml/200 mg with the addition of 0.1% GAA. Further increase of the amount of GAA added from 0.1% to 1% in the case of barley straw shows that this did not further increase the amount of gas formed.

In the case of wheat straw, increase of the amount of GAA from 0.1% to 1% resulted in a further slight increase in the amount of gas from 19.5 ml/200 mg at 0.1% GAA to 20.2 ml/200 mg at 1% GAA. However, this increase is comparatively small.

For maize silage, when 1% GAA was added, the increase in the amount of gas was greater than for maize grains, because for maize silage it increased from 46.2 ml/200 mg to 48.8 ml/200 mg, i.e., by 2.6 ml/200 mg, and for grain maize from 57.7 ml/200 mg to 58.7 ml/200 mg, i.e., by only 1 ml/200 mg.

No increase in gas formation by additivation with GAA was observed for hay (38.7 ml/200 mg and 38.4 ml/200 mg, respectively) and for oats (pressed) (56.6 ml/200 mg without additivation, 56.2 ml/200 mg when additivated with 0.1% GAA, and 56.5 ml/200 mg when additivated with 1% GAA.

In the case of oats and hay, there is obviously no influence of GAA on the HFT value (gas formation).

As an example, the influence of other guanidines was investigated in barley straw.

A positive effect on gas formation was found with the addition of 0.1% guanidine hydrochloride and 0.1% L-arginine. Here, gas formation increased from 22.6 ml/200 mg for the reference sample to 23.8 ml/200 mg in the case of guanidine hydrochloride and 25.9 ml/200 mg in the case of arginine. Completely surprisingly, no effect on gas formation was found when barley straw was additivated with 1,1,3,3-tetramethylguanidine and creatine.

It is surprising at first that creatine has no effect, while an effect is visible with guanidinoacetic acid. Guanidinoacetic acid is the biochemical precursor to creatine. Obviously, this effect does not play a role here and other molecular properties must be present that influence gas formation.

Comparing the structures of guanidine hydrochloride, guanidinoacetic acid and arginine with creatine and 1,1,3,3-tetramethylguanidine, one sees that the guanidine moiety is unsubstituted in the former (guanidine hydrochloride) or monosubstituted (guanidinoacetic acid and arginine) and that in the latter (creatine and 1,1,3,3-tetramethylguanidine) there is a double substitution on at least one N atom.

Without being bound by theory, it is suspected that there is steric hindrance of the guanidine moiety by the multiple substitution, so that it cannot exert any effect. Possibly, without being bound by theory, the effect of the unsubstituted guanidine or monosubstituted guanidinoacetic acid and arginine as a chaotropic compound to break hydrogen bonds is the decisive factor for the observations of increased gas release made here.

The percentage increase in the gas formation value due to additivation with guanidinoacetic acid is greatest for the straw varieties wheat and barley, being 16.76% and 11.95%. This is followed by maize silage, being 5.63%. In the case of maize grains, the increase was only slight at 1.73%, and in the case of hay and oats (pressed) it was no longer present or even slightly negative.

A clear correlation of the results with the content of lignin, hemicellulose or cellulose from the literature or with the energy content of the plant component itself did not yield a clear result. Since lignin, hemicellulose, or cellulose are complex molecules with different structures depending on the plant species, it is suspected, without being bound by theory, that supplementation with guanidinohydrochloride, guandinoacetic acid, or with arginine influences the digestibility of the hemicellulose structures and/or cellulose units of straw and silage maize, i.e. accelerates it.

1. Use of a compound selected from the group of guanidine, guanidinoacetic acid and arginine and salts thereof for increasing the metabolic energy of a feed for ruminants containing straw and/or maize.

2. Use of a compound selected from the group of guanidine, guanidinoacetic acid and arginine and salts thereof for increasing the metabolic energy of a feed containing straw and/or maize in the digestive tract of ruminants.

3. The use according to any one of the preceding claims, characterized in that a salt of the compounds is used as the compound, the salt being selected from the group of alkali salts or alkaline earth salts or hydrochlorides.

4. The use according to any one of the preceding claims, characterized in that guanidinoacetic acid or a salt of guanidinoacetic acid is used as the compound.

5. The use according to any one of the preceding claims, characterized in that the straw is selected from the group of barley straw, wheat straw, oat straw, rye straw, triticale straw, millet straw, and/or in that the maize is used in the form of cob maize, husk cob meal, maize meal, green maize, silage maize, silage maize from the whole plant.

6. The use according to any one of the preceding claims, characterized in that the compound is added to the feed.

7. The use according to any one of the preceding claims, characterized in that the feed contains at least 30% by weight of straw and/or maize, based on the total weight of the feed.

8. The use according to any one of the preceding claims, characterized in that the compound is added to the feed in an amount of from 0.01 to 2% by weight, based on the feed.

9. The use according to any one of the preceding claims, characterized in that the compound is added to the feed in an amount of 0.05 to 1.5% by weight, based on the feed.

10. The use according to any one of the preceding claims, characterized in that the compound is added to the feed in the form of a granulate, extrudate or solution.

11. The use according to any one of the preceding claims, characterized in that the compound is applied onto a carrier material.

12. The use according to any one of the preceding claims, characterized in that the ruminant is a bovine, a dairy cow, a sheep or a goat.

13. A method for increasing the metabolic energy of a feed for ruminants containing straw and/or maize, comprising the steps of
providing a feed for ruminants containing straw and/or maize,
adding a compound selected from the group of guanidine, guanidinoacetic acid and arginine and salts thereof to the feed,
administering the feed to ruminants, and
increasing the metabolic energy of the feed in the digestive tract of the ruminants.
